(19) United States
(12) Patent Application Publication
(10) Pub. No.: US 2025/0123165 A1
(43) Pub. Date: Apr. 17, 2025

(54) METHOD AND DEVICE FOR MEASURING TORQUE

(71) Applicant: Schaeffler Technologies AG & Co. KG, Herzogenaurach (DE)

(72) Inventors: Joachim Hemmer, Schesslitz (DE); Johannes Sauer, Forchheim (DE); Arkady Pankevich, Adelsdorf (DE); Frank Landgraf, Muenster (DE)

(73) Assignee: Schaeffler Technologies AG & Co. KG, Herzogenaurach (DE)

(21) Appl. No.: 18/293,800

(22) PCT Filed: Jul. 13, 2022
(86) PCT No.: PCT/DE2022/100498

§ 371 Date: Jan. 31, 2024

(30) Foreign Application Priority Data
Aug. 6, 2021 (DE) 10 2021 120 462.3

(51) Int. Cl. G01L 3/10; B60G 21/04

(52) U.S. Cl. CPC G01L 3/102; B60G 21/04; B60G 2400/98

(57) ABSTRACT

A method for measuring torque includes low-pass filtering of a signal supplied by a torque sensor, an analog signal supplied by the torque sensor being first digitized and then processed and forwarded as a digital signal having low-pass characteristics.

### CROSS-REFERENCE TO RELATED APPLICATIONS

This application is the U.S. National Phase of PCT Application No. PCT/DE2022/100498 filed on Jul. 13, 2022, which claims priority to DE 10 2021 120 462.3 filed on Aug. 6, 2021.

### TECHNICAL FIELD

The disclosure relates to a method for measuring torque which includes low-pass filtering of a signal. The disclosure further relates to a device suitable for measuring torque.

### BACKGROUND

From DE 10 2013 207 936 A1 is known a method for determining the speed of a shaft. Unlike common methods for measuring speed, this method is based on a torque signal detected by a torque sensor. Magnetostrictive sensors are mentioned in DE 10 2013 207 936 A1 as possible sensors for measuring torque. Such sensors exploit relationships between deformations of magnetized machine elements and changes in the magnetic field. DE 10 2013 207 936 A1 proposes determining the torque of a shaft from a torque signal detected by a torque sensor by filtering using a low-pass filter. This assumes that the torque sensor generates an analog torque signal, which is fed to the low-pass filter. After low-pass filtering, either a digital or an analog signal can be present.

DE 10 2014 201 870 A1 discloses a chassis stabilizer having a magnetostrictive torque sensing device. The torque detection device is intended to detect a torque between two stabilizer parts, wherein a flange part is connected to one of the stabilizer parts to which a torque sensor is positively attached by means of a carrier part. A back side of the carrier part can be shielded by means of a slotted metal disk. DE 10 2014 201 870 A1 makes no statement regarding details of signal evaluation.

A bottom bracket with torque sensors, which is based on the magnetostrictive principle, is known, for example, from EP 2 225 543 B1. In this case, two magnetizations of a rotating component subjected to torque can interact with a common coil as a sensor. A separate sensor may be available for speed measurement.

The object of DE 10 2013 214 580 B4 is a driven wheel bearing unit with integrated measuring of torque. In this case, the underlying measuring principle is correctly referred to as the inverse magnetostrictive effect. A coil or a semiconductor sensor can be used as a sensor that detects the change in magnetic properties.

Various measurement methods and devices that combine high-pass filtering and low-pass filtering are described in the documents DE 196 21 185 A1 and DE 36 25 241 C2. In both cases, low-pass filtering is followed by high-pass filtering and at least one further signal processing step.

Methods of signal processing in motor vehicle technology, which include bandpass filtering of signals, are described, for example, in the documents DE 100 25 631 A1 and EP 1 264 749 B1. In the latter case, a low-pass filter is also used.

With regard to further possible applications of bandpass filters in measurement technology, reference is made to the documents EP 1 153 270 B1 and EP 3 120 135 B1 as examples. In the latter case, signal processing takes place using a tunable bandpass filter.

### SUMMARY

The disclosure is based on the object of specifying methods of measuring torque with low-pass filtering that have been further developed compared to the prior art, which are distinguished by a particularly favorable ratio between equipment cost and interference immunity.

This object is achieved according to the disclosure by a method for measuring torque described herein. Furthermore, the object is achieved by a device for measuring torque described herein. The embodiments of the disclosure explained below in connection with the method for measuring torque also apply mutatis mutandis to the apparatus designed to carry out such measurements, and vice versa.

The method for measuring torque assumes that an analog signal is supplied by a torque sensor. This analog signal is first digitized and then further processed as a digital signal, wherein the digital further processing includes a filtering with a low-pass characteristic.

On the one hand, digital low-pass filtering has the advantage that, in principle, any interference that is coupled into an analog signal in the form of electromagnetic waves cannot play a role. Such interferences can only be of importance within a signal transmission path between the torque sensor and the A/D converter used for digitization, wherein this distance can be kept short by arranging the components that carry out the digital signal processing, including filtering, close to the torque sensor. In addition, known means for shielding components can in principle be used. Another advantage of digital low-pass filtering is that the filtering parameters can be changed in a simple manner, especially using software.

The disclosure is based on the consideration that even weak analog interference signals, for example on the order of a few mV, within certain frequency ranges, for example at frequencies of more than 5 kHz, pose a significantly increased risk that an output signal, which is typically in the range from 0 V to 5 V, will exceed a specified tolerance band. This risk is drastically reduced by digital low-pass filtering. In comparison to conventional solutions, which can in particular include analog low-pass filtering, the digital low-pass filter represents an effective means of making the measuring of torque more robust against external high-frequency interference.

If in the present case it is possible at all to couple interfering signals into the analog working part of the torque measuring device, such interferences have a high frequency in practically all applications compared to the data rate at which the digitized torque values are to be output. This enables a highly efficient elimination of interfering influences using the completely digital low-pass filter. In particular, the low-pass filter can be implemented using software, in other words, designed as a software filter. Since the filter makes a significant contribution to optimizing electromagnetic compatibility, i.e., the EMC properties, it is also referred to as an EMC software filter.

The input-side data rate of the low-pass filter is typically a multiple of the output-side data rate of the low-pass filter. For example, the data rate is reduced by low-pass filtering to a quarter, an eighth, or an even smaller fraction of the original data rate, that is, that given on the input side of the low-pass filter. In particular, the data rate can be reduced to a tenth of the data rate given before the low-pass filtering and already present in the form of a digitized data stream.

According to various possible embodiments, the torque sensor is sampled at intervals of 100 μs to 300 μs (100 microseconds to 300 microseconds), while the digital low-pass-filtered signal is forwarded at intervals of 1 to 3 ms (1 to 3 milliseconds), in particular to a control device integrated into a data bus. The control unit can be used to link the data from measuring torque, in particular, to other measurement data and to use it in a higher-level control system.

The low-pass filtering, which is carried out exclusively through digital signal processing, can be implemented in a simple manner, for example, by calculating the arithmetic mean of at least five and at most 20, in particular exactly ten, consecutive digitized torque values. A new mean value calculation can be carried out with each new, digitally available torque value. It is also possible to carry out the average calculations only at longer time intervals, for example after every second or every fourth or every tenth digitized measured value. In general, it is possible that the time intervals for which the average calculations are made overlap, as well as the possibility that the time intervals mentioned are lined up next to each other without overlapping.

The measuring of torque can in principle be based on any physical principles, for example on the detection of geometric changes that accompany changes in torque. In particular, the inverse magnetostrictive principle can be used to measure torque. This has, among other things, the advantage that there is no requirement for electrical supply lines to rotating components in which a torque to be measured acts.

The torque sensor can be connected to an evaluation unit, which is also part of the device for measuring torque, by means of a cable via which an analog signal is transmitted. Embodiments of the torque measuring device can also be implemented in which the torque sensor is combined with the evaluation unit to form a structural unit, in particular arranged on a common circuit board. In such a case, there is no need for the cable that transmits analog signals between the torque sensor and the evaluation unit.

In addition to roll stabilizers, which are subjected to a torque that is to be measured using the method according to the application, other application examples include steer-by-wire steering systems, in particular space drive systems. Reference is made in this context, for example, to the documents WO 2017/198549 A1 and U.S. Pat. No. 7,970,514 B2.

### BRIEF DESCRIPTION OF THE DRAWINGS

In the following, an exemplary embodiment of the disclosure is explained in more detail with reference to a drawing. In this:

FIG. 1 shows a schematic representation of an arrangement for measuring torque.

### DETAILED DESCRIPTION

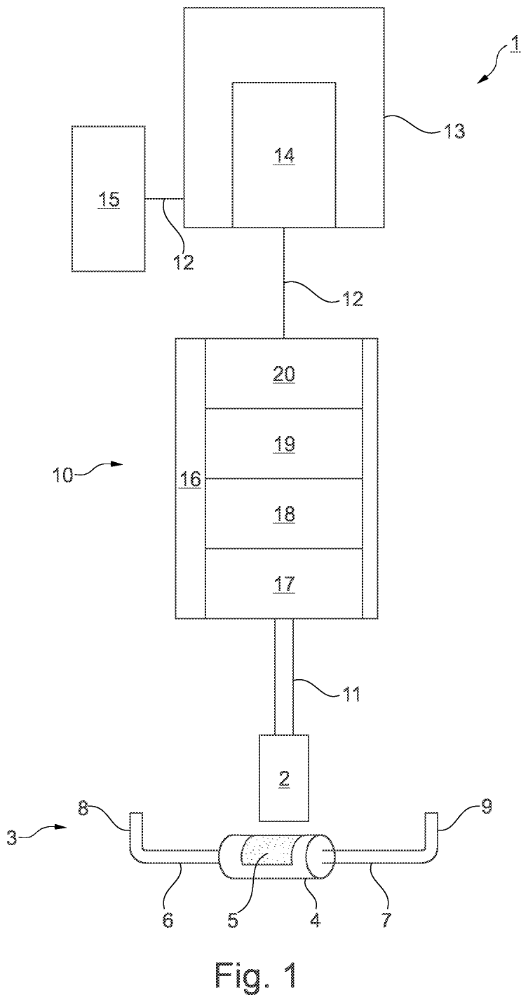

A measuring arrangement for the measuring of torque, marked overall with the reference symbol 1, comprises a torque sensor 2, which is designed to detect a torque acting in a chassis component 3 of a motor vehicle, not shown. The chassis component 3 in the present case is a stabilizer. The chassis component 3 includes a torsion element 4, which has a magnetized region 5. The torsion element 4, which has a cylindrical base shape, is adjoined on both sides by rod-shaped sections 6, 7, which terminate in the form of end sections 8, 9 in the arrangement sketched in FIG. 1. The torque sensor 2 works in a manner known in principle according to the inverse magnetostrictive principle. This takes advantage of changes in the magnetic properties that are due to torsional loads that act in the chassis component 3. With regard to the principal function of the torque sensor 2, reference is made to the prior art cited at the outset.

An evaluation unit, designated overall by 10, is connected to the torque sensor 2 by means of a cable 11, which transmits an analog signal. In a manner not shown, the torque sensor 2 designed to output an analog signal and the evaluation unit 10 can be located on a common circuit board and thus form a structural unit. The evaluation unit 10 in turn is connected to a control device 13 by means of a data bus 12, which is used for digital information transmission. A microcontroller of the control device 13 is labeled with reference symbol 14. The control device 13 is also linked to a further data processing unit 15 via the data bus 12. By means of the data processing unit 15, further control and regulation functions can be implemented within the motor vehicle. In particular, the data processing unit 15 uses torque signals for higher-level control.

The evaluation unit 10 to be assigned to the measuring arrangement 1 comprises a microcontroller 16. Further components of the evaluation unit 10 are an analog-digital converter 17 and three processing modules 18, 19, 20. The block-by-block representation of the processing modules 18, 19, 20 does not necessarily mean that they are physically separate units.

In any case, the evaluation unit 10 receives an analog signal, which is transmitted by cable or via conductor tracks from the torque sensor 2. The output voltage of the torque sensor 2 is in the range 0 volts to 5 volts, wherein the magnetic field typically specified in μT (microtesla) and detected by the torque sensor 2 is assigned a voltage in the specified range. This voltage is converted into a digital value using the analog-digital converter 17. Further signal processing is carried out completely digitally.

First, in the first processing module 18, which is also referred to as a calculation module, a torque is calculated from the value digitized by means of the analog-digital converter 17. The second processing module 19 represents a transmission module, which is designed to pass on the digitized torque signal within the evaluation unit 10, optionally also to other receivers via the data bus 12. In the present case, the torque sensor 2 is sampled at time intervals of 100 μs to 300 μs (100 microseconds to 300 microseconds), which corresponds to the transmission rate of the transmission module 19.

A software filter is connected downstream of the transmission module 19 as a third processing module 20. With the help of the software filter 20, the EMC properties (electromagnetic compatibility) of the measuring arrangement 1 in particular are optimized compared to conventional solutions. The software filter 20 has the characteristics of a low-pass filter. This is achieved by continuously forming average values from several, in this case ten, signals which are supplied by the transmission module 19. As a result, a low-pass-filtered digital torque signal is transmitted from the evaluation unit 10 via the data bus 12 to the control device 13, wherein the time intervals between the averaged digitized values are in the range of 1 ms to 3 ms (1 millisecond to 3 milliseconds). Compared to the data rate that is to be processed by the microcontroller 16 of the evaluation unit 10, the data rate is reduced by a factor of 10.

The feeding of analog interference signals into the measuring arrangement 1 is conceivable in two different ways: On the one hand, high-frequency changes in the magnetic field detected by the torque sensor 2 represent a conceivable interference. On the other hand, feeding high-frequency signals into the cable 11 is conceivable. The frequency of the interference signal can be in the range of more than 5 kHz. Regardless of the source of the interference, these are eliminated with high efficiency by the software-based low-pass filter 20. The digitally low-pass-filtered signals are transmitted from the evaluation unit 10 to the control device 13 without any relevant time delay. In the present case, the torsion element 4 is part of an active roll stabilizer.

### LIST OF REFERENCE SYMBOLS

1 Measuring arrangement
2 Torque sensor
3 Chassis component
4 Torsion element
5 Magnetized region
6 Rod-shaped section
7 Rod-shaped section
8 End section
9 End section
10 Evaluation unit
11 Cable for transmitting an analog signal
12 Data bus
13 Control unit
14 Microcontroller of the control unit
15 Data processing unit
16 Microcontroller of the evaluation unit
17 Analog-to-digital converter
18 First processing module, calculation module
19 Second processing module, transmission module
20 Third processing module, software filter

1. A method for measuring torque via a low-pass filter processing of a signal supplied by a torque sensor, the method comprising:
supplying an analog signal via the torque sensor;
obtaining a digitized signal from the analog signal; and
processing and forwarding the digitized signal as a digitized signal with low-pass characteristics.

2. The method according to claim 1, wherein a data rate of the digitized signal with low-pass characteristics is reduced via low-pass filtering to one-eighth or a smaller fraction of a original data rate of the digitized signal before low-pass filtering.

3. The method according to claim 1, wherein the torque sensor is configured to be sampled at time intervals of at least 100 μs and at most 300 μs.

4. The method according to claim 1, wherein the digitized signal with low-pass characteristics is forwarded at time intervals of at least 1 ms and at most 3 ms.

5. The method according to any one of claim 2, wherein the low-pass filtering is accomplished by forming an arithmetic mean of several consecutive digitized torque values.

6. The method according to claim 5, wherein for low-pass filtering, an arithmetic mean of at least five and a maximum of 20 consecutive digitized torque values is calculated.

7. A method according to claim 1, wherein a measuring of torque via the torque sensor is determined via detection of magnetic parameters.

8. A device for measuring torque, comprising a torque sensor and an evaluation unit connected thereto, the device configured to carry out the method according to claim 1.

9. The device according to claim 8, wherein the evaluation unit is connected to the torque sensor via a cable configured for transmitting an analog signal.

10. The device according to claim 8, wherein the torque sensor is combined with the evaluation unit to form a structural unit.

11. The method according to claim 1, wherein the analog signal supplied by the torque sensor is obtained via an inverse magnetostrictive principle.

12. The method according to claim 2, wherein the low-pass filtering occurs via an EMC software filter.

13. The device according to claim 8, wherein the device is configured to detect a torque in a chassis component of a vehicle.

14. A method for measuring torque of a chassis component of a vehicle, comprising:
supplying an analog signal via a torque sensor;
converting the analog signal to a digital signal having a first data rate; and
processing the digital signal via a low-pass filter to obtain a low-pass-filtered digital signal having a second data rate less than the first data rate.

15. The method according to claim 14, wherein the chassis component is an active roll stabilizer.

16. The method according to claim 14, wherein the analog signal supplied by the torque sensor is obtained via a torsion element arranged on the chassis component, the torsion element having a magnetized region.

17. The method according to claim 14, wherein the second data rate is a fraction of the first data rate, the fraction ranging from one-quarter to one-tenth.

18. The method according to claim 14, wherein the low-pass-filtered digital signal is configured to be forwarded at intervals of 1 to 3 milliseconds to a control device.

19. The method according to claim 14, wherein the torque sensor is sampled at intervals of 100 to 300 microseconds.

20. The method according to claim 14, wherein the analog signal of the torque sensor ranges between 0 volts and 5 volts.
